(19) United States
(12) Patent Application Publication
(10) Pub. No.: US 2020/0306021 A1
(43) Pub. Date: Oct. 1, 2020

(54) HIGH EFFICIENCY DENTAL CHAIR-SIDE TRAP INSERT

(71) Applicant: Packs Solutions LLC, Hudson, OH (US)

(72) Inventor: William Purves, Hudson, OH (US)

(73) Assignee: Packs Solutions LLC, Hudson, OH (US)

(21) Appl. No.: 16/832,033

(22) Filed: Mar. 27, 2020

Related U.S. Application Data
(60) Provisional application No. 62/919,751, filed on Mar. 28, 2019.

(51) Int. Cl. A61C 17/06

(52) U.S. Cl. CPC A61C 17/065; A61G 15/14

(57) ABSTRACT

Provided in this disclosure is a dental filter including a chair-side trap for receiving particles removed from a patient during a dental procedure. The chair-side trap includes a basin for collecting the particles from the patient. The dental filter additionally includes a filter insert sized to be received and retained in the chair-side trap, for preventing the particles to flow outside the chair-side trap. The filter insert is a fabric material including a fine micron cloth that captures particles greater than 5 microns. The filter insert also includes sealed edges around the circumference of the filter insert, where the sealed edges are formed by fusing the fabric material.

This application claims the benefit of U.S. Provisional Application No. 62/919,751, entitled HIGH EFFICIENCY DENTAL CHAIR-SIDE TRAP INSERT, filed Mar. 28, 2019, which is fully incorporated herein by reference.

### I. BACKGROUND

### A. Technical Field

This invention pertains to the field of dental waste disposal. The invention particularly pertains to the field of dental chair-side traps used for collecting particles from patients.

### B. Description of Related Art

In times past, cavities in the teeth of dental patients were filled with amalgam, a material that includes 50% mercury. Since mercury is known to be a toxic heavy metal, substitute dental filling materials have been developed in more recent times that do not include amalgam. In some instances, amalgam fillings are replaced when subsequent dental work is performed in a patient's teeth.

During such dental procedures, particles are captured from a dental chair-side trap that are a combination of amalgam, tooth, tissue, cleaning and polishing paste. Based upon the U.S. EPA findings, amalgam is currently classified as a hazardous substance due to its mercury content. The EPA thus requires that all dental practices that place or remove amalgam must control the discharge of amalgam waste to 95% efficiency (in accordance with 40 CFR 441.30). The existing chair-side trap used in dental practice captures particles that are 1/16 inch or larger which is less than 25% efficiency. As a result of the new EPA rules, the cuspidor that was traditionally used in the dental practice can no longer be used when placing or removing amalgam.

### II. SUMMARY

Provided in this disclosure is a dental filter including a chair-side trap for receiving particles removed from a patient during a dental procedure. The chair-side trap is sized to be received in a corresponding opening of a collection canister. The chair-side trap includes a basin for collecting the particles from the patient. An elevated rim is provided around a circumference of the basin. One or more high volume evacuator (HVE) ports are provided for receiving a respective number of HVE hoses. A saliva ejector (SE) port is provided for receiving a respective SE hose.

The dental filter additionally includes a filter insert sized to be received and retained in the chair-side trap, for preventing the particles to flow outside the chair-side trap. The filter insert is sized to be surrounded and enclosed by a height of the rim. The filter insert is formed of a fabric material including a fine micron cloth that captures particles greater than 5 microns. The filter insert also includes one or more respective HVE apertures sized for receiving the one or more HVE ports. The filter insert also includes a respective SE aperture sized for receiving the SE port. The filter insert also includes sealed edges around the circumference of the filter insert, where the sealed edges are formed by fusing the fabric material.

According to an aspect of the invention, a dental filter is provided that captures small particles produced during dental procedures.

According to another aspect of the invention, a dental filter is provided that offers improved capture of amalgam during dental procedures.

According to yet another aspect of the invention, a dental filter is provided that provides greater compliance with EPA regulations.

Other benefits and advantages of this invention will become apparent to those skilled in the art to which it pertains upon reading and understanding of the following detailed specification.

### III. BRIEF DESCRIPTION OF THE DRAWINGS

The disclosed dental trap filter insert may take physical form in certain parts and arrangement of parts, embodiments of which will be described in detail in this specification and illustrated in the accompanying drawings which form a part hereof and wherein:

FIG. 1 is a perspective view of a dental trap filter insert in accordance with an exemplary embodiment of the present invention.

FIG. 2 is an exploded view of a dental trap filter insert in cooperation with a chair-side trap in accordance with an exemplary embodiment of the present invention.

FIG. 3 is an exploded view of a dental trap filter insert in cooperation with a chair-side trap in accordance with an alternative exemplary embodiment of the present invention.

FIG. 4 is a perspective view of a dental trap filter insert in a chair-side trap in accordance with a further alternative exemplary embodiment of the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

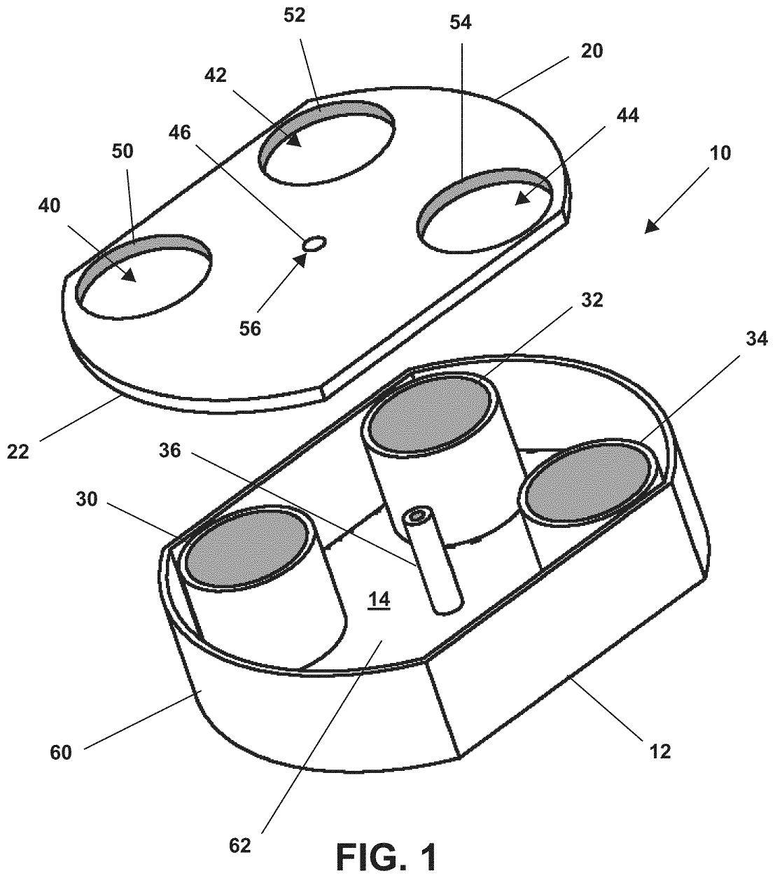

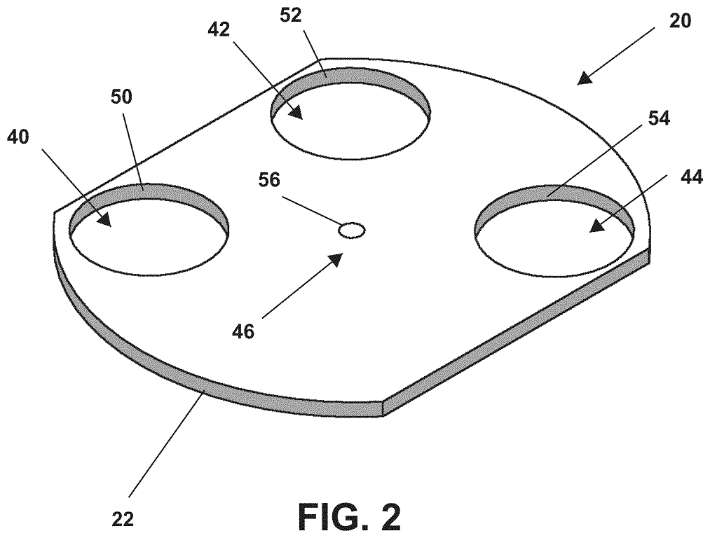

As shown in FIGS. 1 and 2, a dental filter 10 is provided including a chair-side trap 12 for receiving particles removed from a patient during a dental procedure. In particular, the chair-side trap 12 includes a basin 14 for collecting the particles from the teeth of the patient produced during the dental procedure. A filter insert 20 is sized to be received and retained in the chair-side trap 12. The filter insert 20 prevents the particles from the patient's teeth from flowing outside the chair-side trap 12.

As depicted in FIGS. 1 and 2, the filter insert 20 is formed of a fabric material for filtering micro-sized particles. The fabric material of the filter insert 20 can be of the type commonly used in water and waste water treatment processes. In the preferred embodiment, the fabric material comprises a fine micron cloth that captures particles greater than 5 microns. In this manner, the fabric material of the filter insert 20 captures more than 95% of the particles including amalgam and thereby meets the EPA requirements.

In the preferred embodiment, the fabric material of the filter insert 20 is a type of Polyester Felt Filter Media sold by Duda Energy LLC of Decatur, Ala., and made for the primary purpose of “polishing” water in water treatment plants. The filter media is made of a micron-rated polyester felt, a non-woven fabric in which small polymer fibers of varying diameters and lengths are forced into a matrix. One side of the material is singed, a process that further locks the filaments together on the “downstream” surface, thereby improving filtration. This fabric produces filtration on a range based on generally accepted industry tests. Factors influencing the actual filtration include the shape, size, consistency and loading of the contaminants. Also, the feed pressure and rate of flow affects the filtration results. Polymer Felt Filter Media has a far higher dirt capacity and flow rate than a flat woven type material known in the prior art, and is therefore more resistant to blinding (clogging). Due to material limitations, the filter insert 20 formed of this type of fabric material is preferably disposable.

As shown in FIGS. 1 and 2, the filter insert 20 is cut from the fabric material into the precise shape of the chair-side trap 12. The cutting and placement of the filter insert 20 is important to the efficiency of the chair-side trap 12. In this manner, the filter insert 20 fits securely into the chair-side trap 12 so that the particles from the patient are captured from the chair-side trap 12, including amalgam, tooth, tissue, cleaning and polishing paste. The fabric material of the filter insert 20 is layered such that particles can be captured without affecting the vacuum system and trap system.

In order to more fully ensure the particles are captured, sealed edges 22 of the filter insert 20 are formed around a circumference of the filter insert 20. The sealed edges 22 are formed by fusing the fibrous edges of the fabric material, thereby giving the filter insert 20 a precise fit into the chair-side trap 12. This sealing can be performed during the cutting of the fabric material by cutting with a laser that partially melts the edges of the fabric material of the filter insert 20. By creating sealed edges 22, the particles are prevented from flowing through the edges of the fabric, thereby further improving filter performance.

The present chair-side trap 12 replaces the traditional dental cuspidor and cooperates with a vacuum system used to remove saliva, amalgam, paste and any other foreign particle generated in the mouth during dental procedures. The present chair-side trap 12 also includes one or more ports 30, 32, 34, 36 for each receiving and connecting a vacuum hose. In order to accommodate the ports 30, 32, 34, 36, the filter insert 20 includes respective apertures 40, 42, 44, 46 sized for receiving the respective ports 30, 32, 34, 36.

In accordance with standard dental instrumentation, the chair-side trap 12 can include one or more high volume evacuator (HVE) ports. In the illustrated example of FIGS. 1 and 2, three HVE ports 30, 32, 34 are depicted. However, any suitable number can be employed on a chair-side trap 12 without departing from the present invention. Accordingly, the filter insert 20 depicted in the illustrated example includes respective apertures 40, 42, 44 sized for receiving the respective HVE ports 30, 32, 34. Also in accordance with standard dental instrumentation, the chair-side trap 12 can include a saliva ejector (SE) port 36. Accordingly, the filter insert 20 depicted in the illustrated example includes a respective aperture 46 sized for receiving the respective SE port 36.

In another aspect of the invention, the apertures 40, 42, 44, 46 in the filter trap 12 can also include sealed edges 50, 52, 54, 56 formed around an internal circumference of each of the respective apertures 40, 42, 44, 46. As with the sealed edges 22 discussed hereinabove, the sealed edges 50, 52, 54, 56 of the respective apertures 40, 42, 44, 46.22 are formed by fusing the fabric material by cutting the apertures 40, 42, 44, 46.22 into the fabric material with a laser that partially melts the fabric material of the filter insert 20.

In another aspect of the present invention, the chair-side trap 12 includes an elevated rim 60 around a circumference of the basin. The filter insert 12 is sized to be surrounded and enclosed with the height of the rim 60 of the basin 14. The rim 60 is above a base surface 62 of the basin 14, and the rim 60 is generally perpendicular to the base surface 62. The base surface 62 can be formed as a grating in order to support the filter insert 12 but allow fluids to pass through into a collection canister (not shown). The rim 60 and the base surface 62 generally define the basin 14 and are sized so that the chair-side trap 12 is sized to be received in a corresponding opening of the collection canister, so that the particles can be captured and collected.

The filter insert 20 of the present invention is a supplement to the standard amalgam separator that is required under the EPA rules. The filter insert 20 enhances the performance of the amalgam separator and extends the useful life of the unit. The present filter insert 20 also reduces the concentration of hazardous mercury entering the waste stream. The present filter insert 20 can fit inside a plastic housing of a commercially-available chair-side trap. The filter insert 20 can be made to fit nearly any size and configuration of commercially available traps used by dentists.

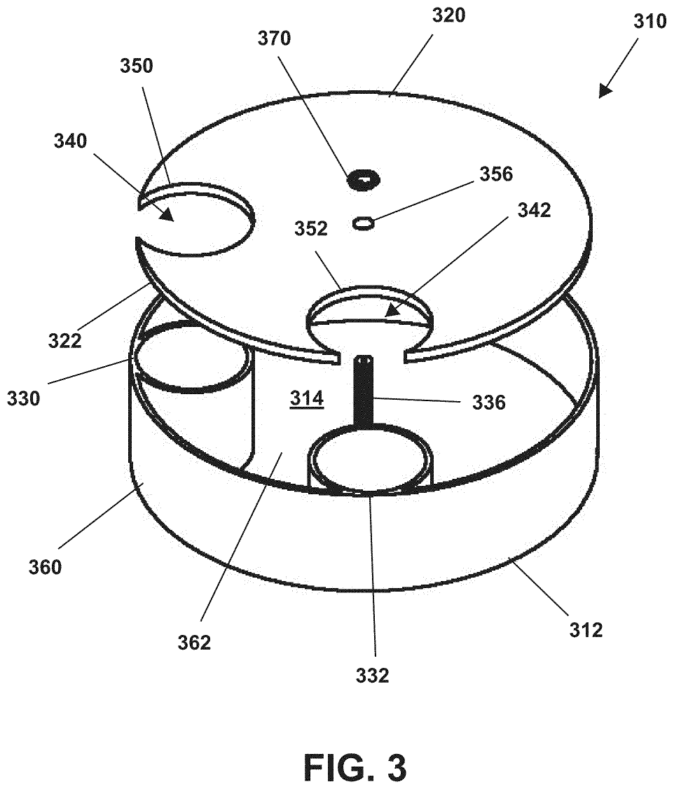

In another aspect of the invention, the present filter can be adapted for any type of filter trap. As shown in FIG. 3, a generally circular dental filter 310 can be contemplated. As with the aforementioned embodiment of FIGS. 1 and 2, a chair-side trap 312 includes a basin 314 and a filter insert 320 is sized to be received and retained in the chair-side trap 312. Sealed edges 322 are formed around a circumference of the filter insert 320. Ports 330, 332, 336 are provided for each receiving and connecting a vacuum hose. In order to accommodate the ports 330, 332, 336, the filter insert 320 includes respective apertures 340, 342, 346 sized for receiving the respective ports 330, 332, 336. The apertures 340, 342, 346 also include sealed edges 350, 352, 356 formed around an internal circumference of each of the respective apertures 340, 342, 346.

The chair-side trap 312 includes an elevated rim 360 around a circumference of the basin. The filter insert 312 is sized to be surrounded and enclosed with the height of the rim 360 of the basin 314. The rim 360 is above a base surface 362 of the basin 314, and the rim 360 is generally perpendicular to the base surface 362. An O-ring 370 is slipped over the port 336 when inserted through the aperture 346 and is used to secure the filter insert 320 during transport and use.

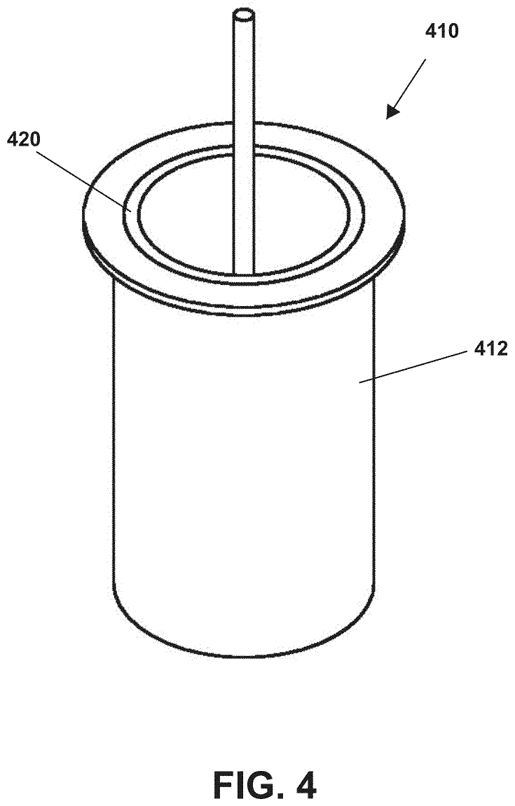

In the embodiment of FIG. 4, a cylindrical dental filter 410 is shown, having a cylindrical chair-side trap 412 that receives a cylindrical filter insert 420. This embodiment is one of many different shapes and sizes of dental filters that can be adapted in accordance with the aspects of the present invention as disclosed hereinabove.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed:

1. A dental filter comprising:
a chair-side trap for receiving particles removed from a patient during a dental procedure, the chair-side trap comprising a basin for collecting the particles from the patient; and
a filter insert sized to be received and retained in the chair-side trap, for preventing the particles from flowing outside the chair-side trap, the filter insert comprising:
a fabric material for filtering micro-sized particles;
sealed edges around a circumference of the filter insert.

2. The dental filter of claim 1, wherein the chair-side trap comprises at least one port for receiving a hose, wherein the filter insert comprises at least one respective aperture sized for receiving the at least one port.

3. The dental filter of claim 2, wherein the at least one port comprises at least one high volume evacuator (HVE) port.

4. The dental filter of claim 2, wherein the at least one port comprises a saliva ejector (SE) port.

5. The dental filter of claim 1, wherein the chair-side trap comprises an elevated rim around a circumference of the basin, wherein the filter insert is sized to be surrounded and enclosed by a height of the rim.

6. The dental filter of claim 1, wherein the chair-side trap is sized to be received in a corresponding opening of a collection canister.

7. The dental filter of claim 1, wherein the fabric material comprises a fine micron cloth that captures particles greater than 5 microns.

8. The dental filter of claim 1, wherein the sealed edges are formed by fusing the fabric material.

9. A dental filter comprising:
a chair-side trap for receiving particles removed from a patient during a dental procedure, and sized to be received in a corresponding opening of a collection canister, the chair-side trap comprising:
a basin for collecting the particles from the patient;
an elevated rim around a circumference of the basin;
at least one high volume evacuator (HVE) port for receiving at least one respective HVE hose;
a saliva ejector (SE) port for receiving a respective SE hose;
wherein the dental filter further comprises:
a filter insert sized to be received and retained in the chair-side trap, for preventing the particles from flowing outside the chair-side trap, the filter insert is sized to be surrounded and enclosed by a height of the rim, the filter insert comprising:
a fabric material comprising a fine micron cloth that captures particles greater than 5 microns;
at least one respective HVE aperture sized for receiving the at least one HVE port;
a respective SE aperture sized for receiving the SE port;
sealed edges around a circumference of the filter insert formed by fusing the fabric material.
